(19) United States
(12) Patent Application Publication
(10) Pub. No.: US 2011/0289733 A1
(43) Pub. Date: Dec. 1, 2011

(54) TEETHER/PACIFIER SECURING DEVICE

(75) Inventors: Maria A. Del Solar, Stamford, CT (US); Diana Sierra, North Bergen, NJ (US)

(73) Assignee: PLAYTEX PRODUCTS, LLC.

(21) Appl. No.: 12/787,076

(22) Filed: May 25, 2010

(51) Int. Cl. A44B 6/00; F16B 2/06

(52) U.S. Cl. 24/3.12; 24/326

(57) ABSTRACT

A securing device connected to a tether including a first clamp portion and a second clamp portion each having a respective first or second exterior surface and interior surface opposite the exterior surface. The first and second clamp portions each have an end that is connected to one another at a connected portion and an opposite free end that is free to form a “C” shape. The connected portion connects the first and second clamp portions to bias the free ends away from each other. A slider is movably connected to the first and second clamp portions so that the slider moves toward and away from the free ends. A ridge is connected to the second exterior surface adjacent the free end of the second clamp portion so that the ridge protrudes from the second exterior surface to be engaged by a user while moving the slider.

### BACKGROUND

1. Field of the Disclosure

The present disclosure relates generally to a teether/pacifier securing device. More particularly, the present disclosure relates to a teether/pacifier securing device that removably connects and tethers a teether/pacifier to a clothing article of a child.

2. Description of Related Art

A pacifier removed from a child's mouth may be moved an undesirable distance from the child or simply unintentionally fall out of the child's mouth resulting in contact with an unwanted surface such as the ground if not tethered and secured to the child. Devices are used to tether the teether or pacifier to the child. Currently, such available devices cannot be secured properly to fabrics of different thicknesses. Such devices undesirably fall off of some fabrics or simply cannot be used therewith. Also, such available devices require both hands to connect the device to the fabric. Accordingly, care takers are undesirably required to use two hands prohibiting other activity, for example, holding the child while connecting the device.

Accordingly, there is a need for a securing device that can be operated to secure the tethered pacifier or teether to fabric using one hand. There is a further need for such a securing device that can be secured to fabric of varying thicknesses.

### SUMMARY

The present disclosure provides for a securing device connected to a tether that in turn is connected to a teether or pacifier. The securing device includes a first clamp portion having a first exterior surface and a first interior surface opposite the first exterior surface. A second clamp portion has a second exterior surface and a second interior surface opposite the second exterior surface. The first clamp portion and the second clamp portion each have an end that is connected to one another at a connected portion and opposite free ends that are free forming a “C” shape. The connected portion connects the first clamp portion and the second clamp portion to bias the free ends away from each other. A slider is movably connected to the first clamp portion and the second clamp portion so that the slider is movable toward and away from the free ends. A ridge is connected to the second exterior surface adjacent the free end of the second clamp portion so that the ridge protrudes from the second exterior surface to be engaged by a user while moving the slider.

The above-described and other advantages and features of the present disclosure will be appreciated and understood by those skilled in the art from the following detailed description, drawings, and appended claims.

### BRIEF DESCRIPTION OF THE DRAWINGS

FIG. 1 is a side plan view of an exemplary embodiment of a pacifier/teether securing device according to the present disclosure.

FIG. 2 is a top plan view of the device of FIG. 1.

FIG. 3 is a top side perspective view of the device of FIG. 1.

FIG. 4 is a top plan view of a clamp of the device FIG. 1 without a slider.

FIG. 5 is a side plan view of the clamp of FIG. 4.

FIG. 6 is a bottom plan view of the clamp of FIG. 4.

FIG. 7 is a side cross-sectional view of the clamp of FIG. 4 taken along line A-A of FIG. 6.

FIG. 8 is a partial side cross-sectional view of a portion designated “A” in FIG. 7 of the clamp shown FIG. 4.

FIG. 9 is a top side perspective view of the clamp of FIG. 4.

FIG. 10 is an exploded view of a securing device of FIG. 1.

FIG. 11 is a top plan view of a base and a post of the device of FIG. 10.

FIG. 12 is a rear plan view of the base and the post of FIG. 11.

FIG. 13 is a side plan view of the base and the post of FIG. 11.

FIG. 14 is a top plan view of a base of the device of FIG. 10.

FIG. 15 is a rear plan view of the base of FIG. 14.

FIG. 16 is a bottom plan view of the base of FIG. 14.

FIG. 17 is a rear side cross-sectional view along line A-A shown in FIG. 16 of the base of FIG. 14.

FIG. 18 is a front cross-sectional view of the post connected to each base of FIG. 4.

FIG. 19 is a side cross-sectional view of the post connected to each base of FIG. 4.

FIG. 20 is a top plan view of an alternative embodiment of a pacifier/teether securing.

### DETAILED DESCRIPTION OF THE PREFERRED EMBODIMENT

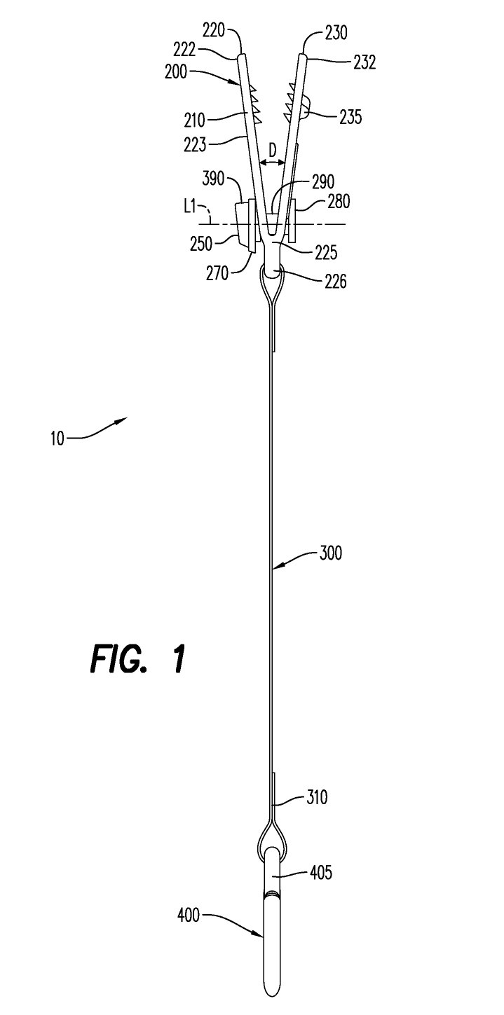

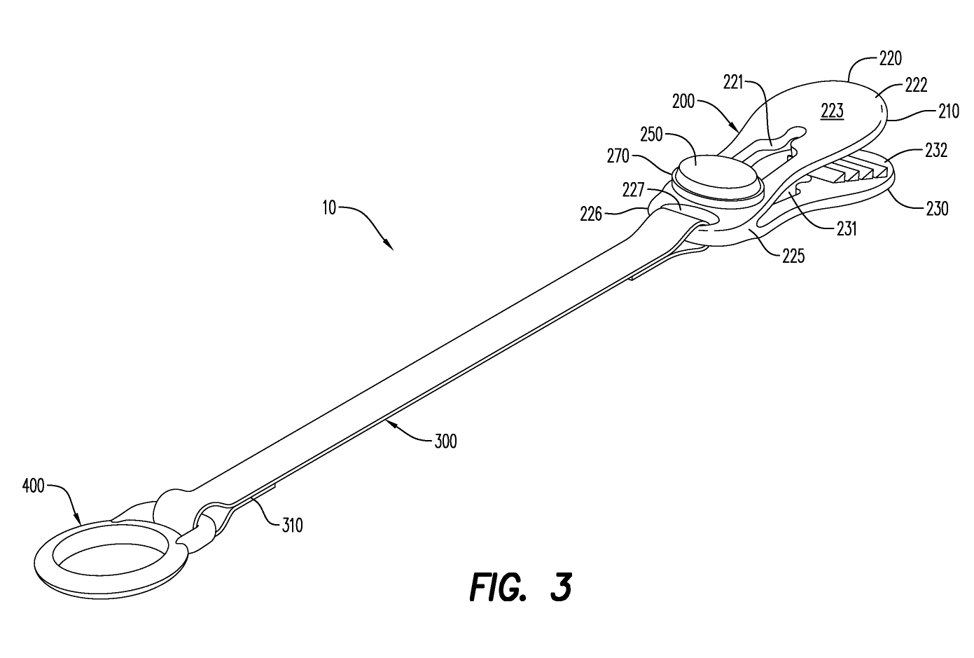

Referring to the drawings and in particular to FIGS. 1-3, an exemplary embodiment of a pacifier/teether securing device assembly according to the present disclosure is generally referred to by reference numeral 10. In particular, the present disclosure is directed to the securing device 200 of the pacifier/teether securing device assembly 10.

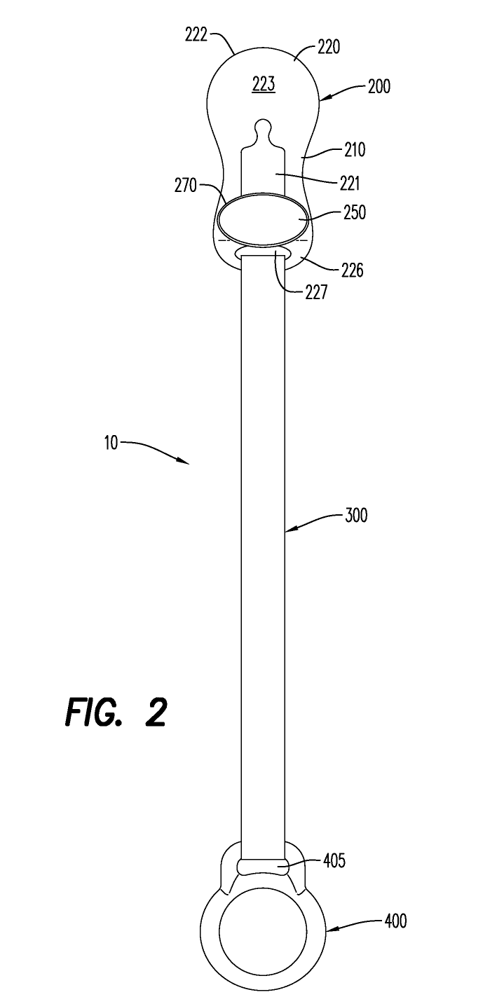

Device 200 is connected to a first end of a tether 300. Tether 300, at its second and opposite its first end, is removably connected to an item, such as a pacifer, or as shown a teether 400. Tether 300 may include a connector 310, for example, a hook and loop fastener, to removably connect teether 400, or pacifier, to the tether. Tether 300 can be any material, but preferably is a flexible material. Teether 400 has a connection loop 405 (shown in FIG. 2) so that tether 300 may be threaded through the connection loop to connect the tether to the teether. Again, teether 400 may be any pacifier, nipple, teether, or any child object for insertion into a child's mouth.

Device 200 has a clamp 210 and a slider 250. Clamp 210 has an hourglass shape, as shown in FIG. 2, that has been found by the present disclosure to be ergonomic. Clamp 210 has a first clamp portion 220 and a second clamp portion 230. First clamp portion 220 is connected to second clamp portion 230 at a connected portion 225 forming a “C” shape, as shown in FIG. 1. First clamp portion 220 is connected to second clamp portion 230 at an angle D of about 10 degrees to about 45 degrees, and preferably about 14.8 degrees. First clamp portion 220 has a first free end 222 on the first clamp portion opposite connected portion 225. Second clamp portion 230 has a second free end 232 on the second clamp portion opposite connected portion 225. First clamp portion 220 and second clamp portion 230 are connected at connected portion 225 to bias first free end 222 away from second free end 232. First free end 222 and second free end 232 separate due to the material and shape of clamp 210 that biases the first free end and second free end away from one another to an open position, as shown in FIG. 1. Connected portion 225 may be connected to a tether connection portion 226 that has an aperture 227 therethrough (shown better in FIG. 2). Tether 300 is threaded through aperture 227 to connect to device 200.

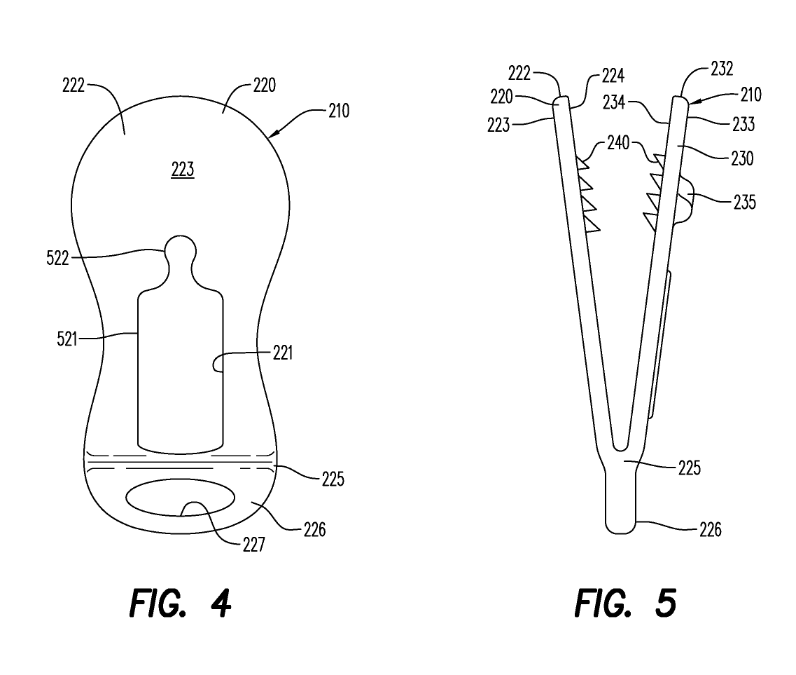

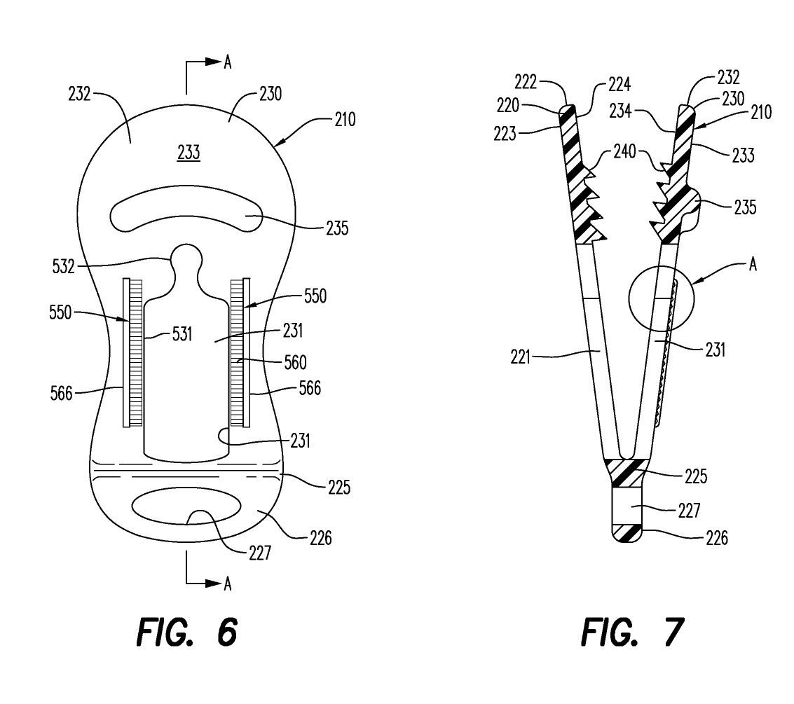

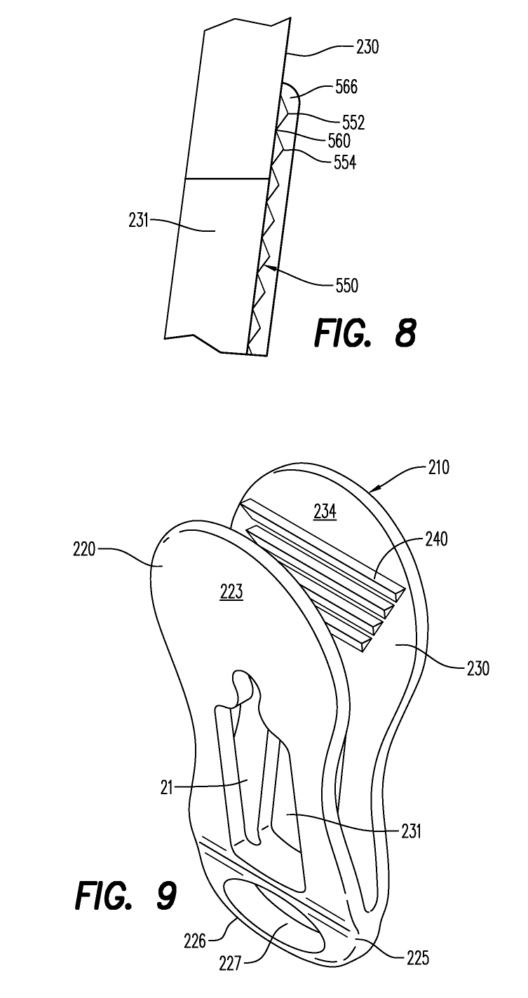

Referring to FIGS. 4-9, first clamp portion 220 has an exterior surface 223 and an interior surface 224. First clamp portion 220 has a first opening 221 through exterior surface 223 and interior surface 224. Referring to FIG. 5, second clamp portion 230 has an exterior surface 233 and an interior surface 234. As best shown in FIG. 6, second clamp portion 230 has a second opening 231 through exterior surface 233 and interior surface 234. Each interior surface 224 and 234 may have teeth 240.

Each of first opening 221 and second opening 231 have a substantially rectangular shape 521 and 531 that connects to a narrowed portion 522 and 532. The narrow portions 522 and 532 may each be a ventilation hole that comply with a predetermined standard, for example, European Standards EN 12586 maintained by the European Committee for Standardization, which is hereby incorporated by reference in its entirety. This standard requires pacifier holders to have a ventilation hole on any flat surface of 25 millimeter (mm) diameter. Alternatively, first opening 221 and second opening 231 may be substantially rectangular without narrowed portions 522 and 532, for example, as shown in FIG. 18 by opening 622 of device 200.

Referring to FIG. 6, exterior surface 233 of second clamp portion 230 has on each side of second opening 231 a plurality of protrusions 550. A groove 560 is formed between each adjacent pair of protrusions, for example, protrusion 552 and protrusion 554, as shown in FIG. 8. In addition, adjacent each of the plurality of protrusions 550 on a side opposite of second opening 231 is a railing 566. Referring now to FIGS. 5-7, exterior surface 233 of second clamp portion 230 has a ridge 235 that protrudes from the exterior surface of the second clamp portion. At least a portion of ridge 235 is between second free end 232 and second opening 231. Ridge 235 may be curved toward second opening 231. Ridge 235 may be softer than a remainder of clamp 210 or have an uneven surface forming a rough texture thereon for gripping benefits. Ridge 235 may be thermoplastic elastomer overmolded onto clamp 210. Clamp 210 excluding ridge 235 may be acrylonitrile butadiene styrene, copolyester, styrene methyl methacrylate acrylic copolymer, polypropylene or equivalent suitable material depending on the material strength and clarity as well as thermoplastic elastomer bonding properties if ridge 235 were to be made out of thermoplastic elastomer.

Referring now to FIG. 10, slider 250 has a first base 270 and a second base 280. Second base 280 is connected to first base 270 by a post 290 so that slider 250 is movable through first opening 221 and second opening 231 toward and away from first free end 222 and second free end 232.

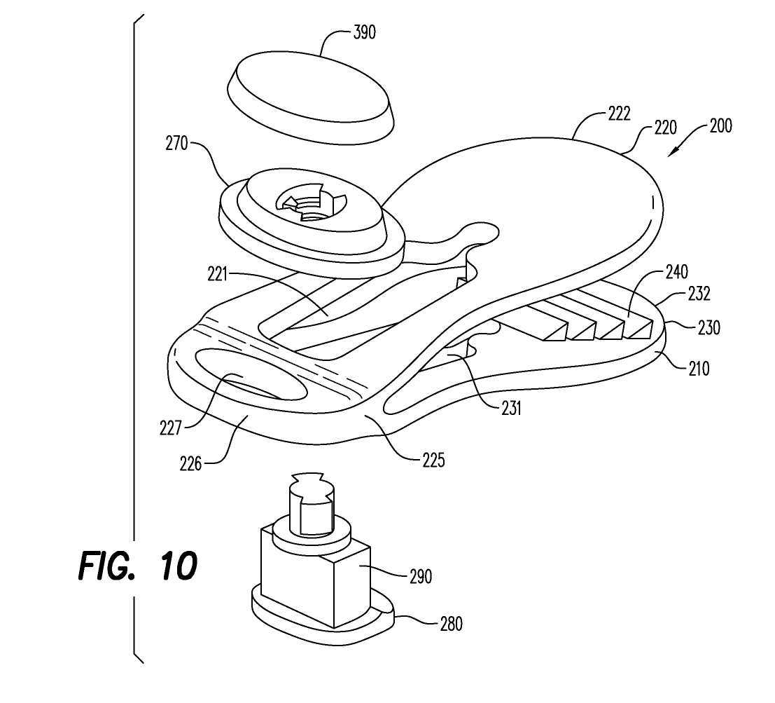

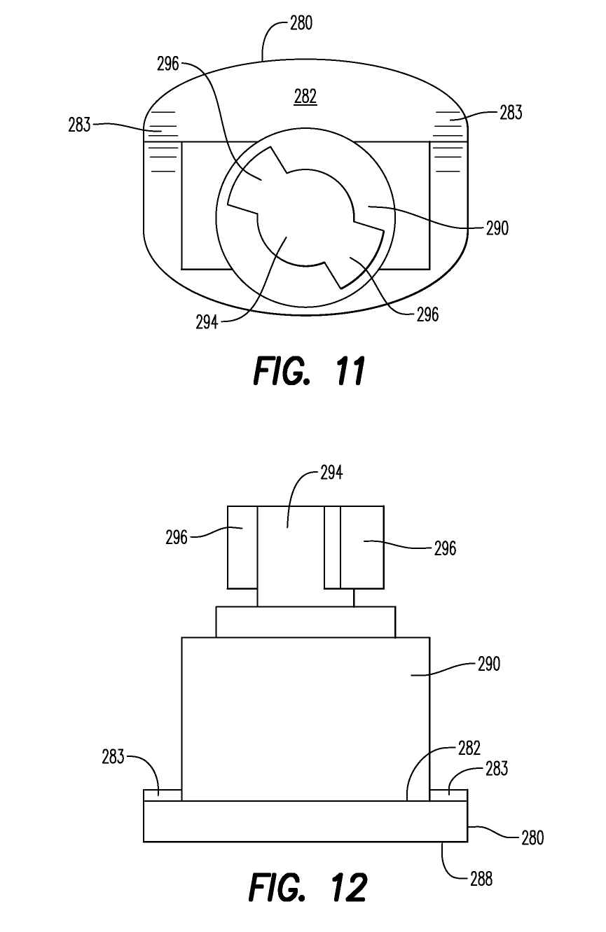

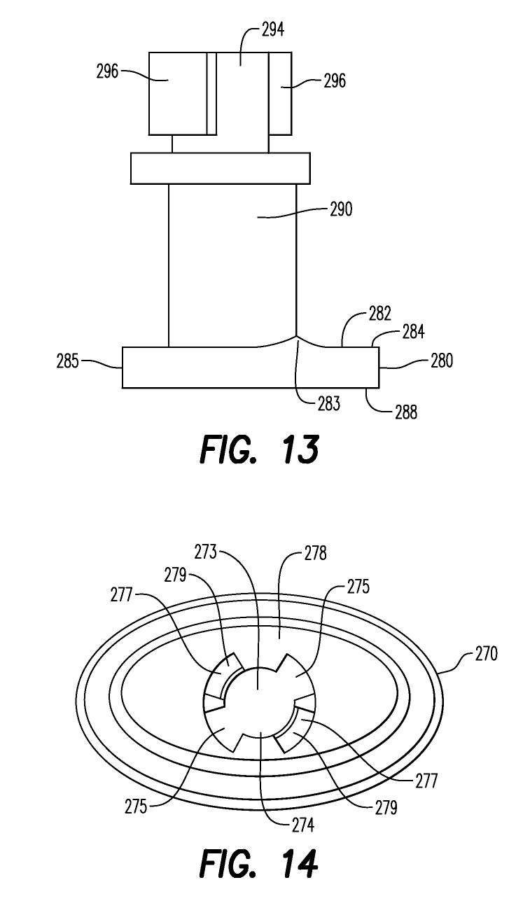

As shown in FIGS. 11-13, second base 280 has an inner surface 282, a portion of which will contact exterior surface 233 of second clamp portion 230 when slider 250 is connected to clamp 210, and an outer surface 288 opposite the inner surface 282. Inner surface 282 has a protrusion 283 that is a single protrusion extending from one end to the next horizontally with a portion of the protrusion being covered by a thickness of post 290. Inner surface 282 of second base 280 excluding protrusion 283 forms an angle with longitudinal axis L1 of post 290 (shown in FIG. 1) of about 90 degrees. Inner surface 282 has protrusion 283 on opposite sides of post 290. Inner surface 282 has a forward end 284 and a rearward end 285 opposite the forward end. Protrusion 283 may be positioned closer to forward end 284 than rearward end 285. Protrusion 283 fits within grooves 560 of second clamp portion 230 when slider 250 is connected to clamp 210.

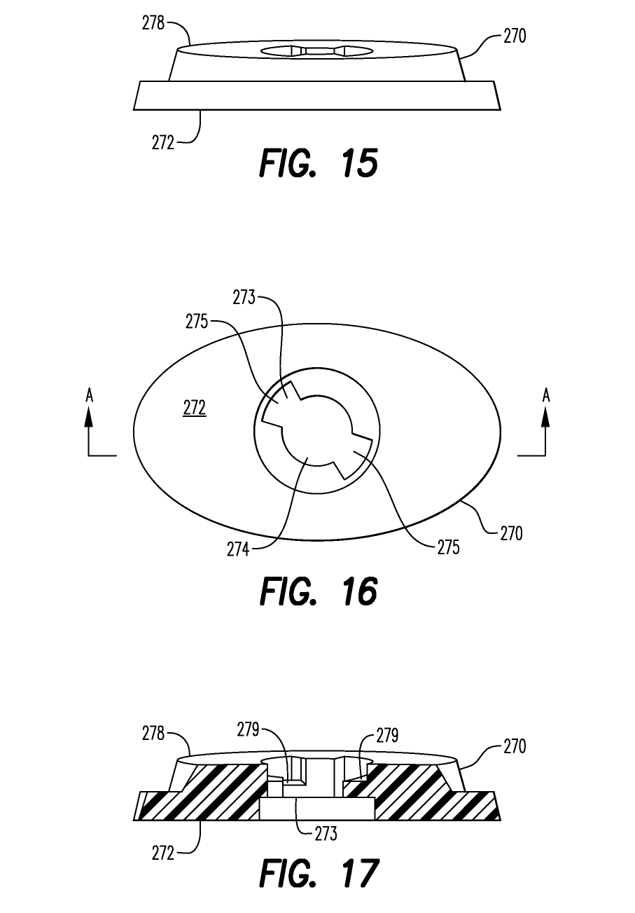

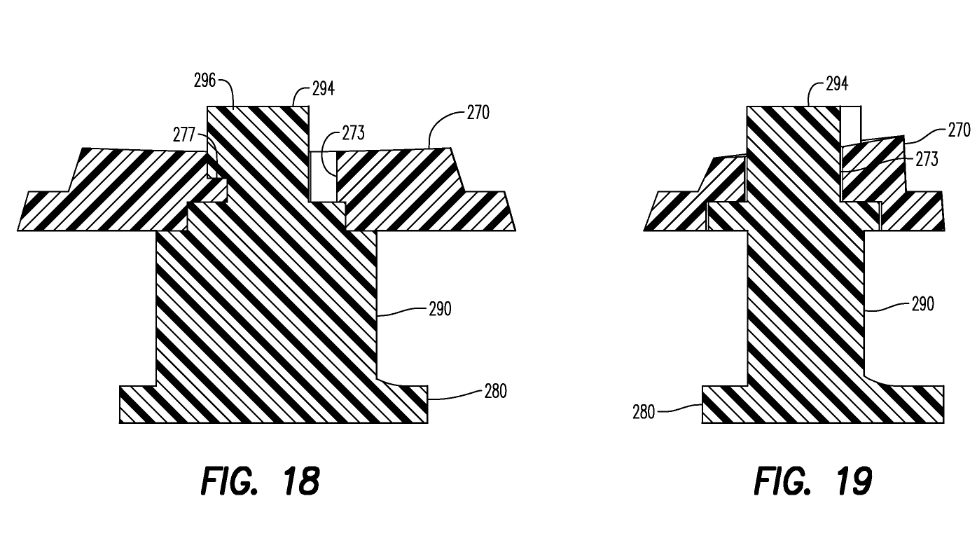

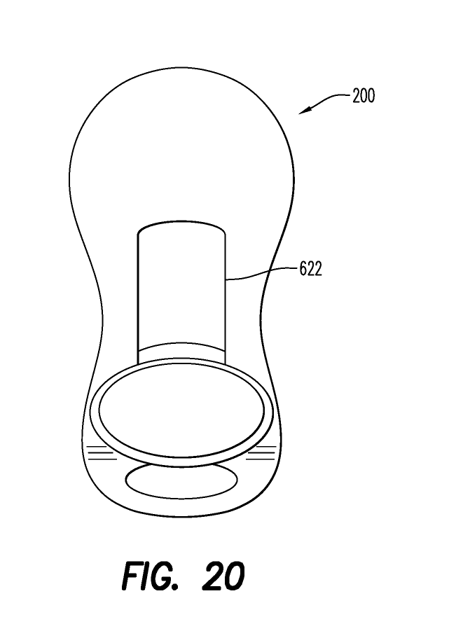

As shown in FIGS. 14-17, first base 270 has an inner surface 272, a portion of which will contact exterior surface 223 of first clamp portion 220 when slider 250 is connected to clamp 210 (as shown in FIG. 1), and an outer surface 278 opposite the inner surface 272. As shown in FIG. 1, inner surface 272 of first base 270 forms an angle with longitudinal axis L1 of post 290 in of about 90 degrees. Post 290 connects first base 270 to second base 280.

Referring again to FIGS. 11-13, post 290 has a stud 294. Stud 294 has a pair of abutments 296 that form a “bowtie” shape. Referring again to FIGS. 14-17, first base 270 has an aperture 273 through inner surface 272 and outer surface 278. Aperture 273 is a complementary shape to stud 294 and has a circular portion 274 and opposite portions 275 that together form a “bowtie” shape. Aperture 273 has a size greater than or equal to the perimeter of stud 294. Outer surface 278 has depressions 279 adjacent opposite portions 275 of aperture 273 that form support surfaces 277.

Referring again to FIGS. 11-17, to connect post 290 to first base 270, stud 294 passes through aperture 273. Post 290 is rotated from a first position where the post can pass through aperture 273 to a connected position, as shown in FIGS. 18 and 19, so that each of the pair of abutments 296 is positioned on one of support surfaces 277, so that stud 294 cannot fit through aperture 273 in the connected position. Stud 294 is then heat staked so that a temperature of the stud is raised to allow a material of the stud to soften. At the same time, a pressure is applied to stud 294 to modify the size of the stud to be wider so that rotating stud 294 to the first position is prevented. The temperature is maintained for a predetermined time to allow the material of stud 294 to soften enough for the pressure to create the desired shape of the stud, then the joined components post 290 and first base 270 are allowed to gradually cool. As materials of post 290 and first base 270 cools, the materials of the post and first base become rigid to create a connection therebetween. Alternatively, first base 270 and stud 294 may be joined by any other connector, for example, adhesive, snap fit, and friction fit.

Referring again to FIGS. 1 and 10, a gripping material 390 is overmolded to connect to first base 270. Gripping material 390 provides friction between a user's fingers or thumbs when positioned on the gripping material assisting the user to move slider 250 toward and away from first free end 222 and second free end 232. Gripping material 390 may be thermoplastic elastomer, rubber, or any other material that enhances gripping.

In operation, post 290 of slider 250 moves in first opening 221 and second opening 231 toward connected portion 225. As post 290 moves in first opening 221 and second opening 231 toward connected portion 225, at least a portion of first base 270 slides along exterior surface 223 of first clamp portion 220, and protrusion 283 slides over protrusions 550 of second clamp portion 230 into and out of grooves 560. Railings 566 may abut each side of second base 280 to keep second base 280 of the slider 250 in track when traveling toward and away from first free end 222 and second free end 232. First free end 222 and second free end 232 separate due to the material and shape of clamp 210 that biases the first free end and second free end away from one another to an open position, as shown in FIG. 1.

Post 290 of slider 250 moves in first opening 221 and second opening 231 toward first free end 222 and second free end 232. As post 290 moves in first opening 221 and second opening 231 toward first free end 222 and second free end 232, at least a portion of first base 270 slides along exterior surface 223 of first clamp portion 220, and protrusion 283 slides over plurality of protrusions 550 into and out of grooves 560. Thus, first base 270 and second base 280 of slider 250 each apply a force to clamp 210 moving first free end 222 and second free end 232 toward each other. The portion of first base 270 that slides along exterior surface 223 of first clamp portion 220 and protrusion 283 apply a force to clamp 210 to overcome the bias of the material and shape of the clamp that separates the first free end and second free end, so that the first free end and the second free end can move toward each other. A distance between first free end 222 and second free end 232 decreases as slider 250 moves toward the first free end and the second free end and increases as slider 250 moves away from the first free end and the second free end. Railings 566 may abut each side of second base 280 to keep second base 280 of the slider 250 in track when traveling toward and away from first free end 222 and second free end 232.

Once first free end 222 and second free end 232 are at a desired distance from one another in a desired position, the user stops moving the slider. Slider 250 is maintained in the desired position when the user stops moving the slider by protrusion 283 on the slider positioned within a pair of grooves 560 on second clamp portion 230 that correspond to the desired position. A force that is great enough to move protrusion 283 over the pair of grooves 560 will move slider 250 from the desired position.

The desired position may secure device 200 to a layer of material, for example, an article of a child's clothing. By moving first free end 222 and the second free end 232 toward each other the layer of material is secured between first clamp portion 220 and second clamp portion 230. Teeth 240 on interior surface 224 and 234 can create additional friction to secure the layer of material between first clamp portion 220 and second clamp portion 230. Accordingly, grooves 560 and protrusion 283 allow first free end 222 and the second free end 232 to be maintained at various distances therebetween so that device 200 can be secured to materials of various thicknesses to connect tether 300 and teether 400 to a child.

Device 200 is ergonomic and easy to hold with one hand. It has been found by the present disclosure that a user can grip device 200 on gripping material 390 with the user's thumb and under ridge 235 with one or more of the user's fingers in order to operate device 200 with one hand. Having slider 250 in a center of device 200 forms an ergonomic shape uninterrupted allowing for one hand use. Accordingly, device 200 allows for one-handed usage that is comfortable and quick for a child's care taker.

It has also been found by the present disclosure that slider 250 having inner surface 272 of first base 270 that forms the angle with longitudinal axis L1 of post 290 of about 90 degrees, and inner surface 282 of second base 280 excluding protrusion 283 that forms an angle with longitudinal axis L1 of post 290 of about 90 degrees moves first free end 222 and second free end 232 toward one another without requiring inclined surfaces connected to either first clamp portion 220 or second clamp portion 230 to direct slider 250. If inclined surfaces are connected to clamp 210 to guide slider 250, these inclined surfaces can break during use and are undesirable during manufacturing. The inclined surfaces, would also take away from the ergonomics and one handedness of device 200 since the inclined surfaces would add material to surface 210.

Device 200 removably connects to a clothing item worn by a child, for example, an infant, to connect teether 400 to the child via tether 300. Device 200 that is connected to a child and is connected to tether 300 prevents teether 400 from moving away from a child beyond a predetermined distance allowing the child to insert and remove the teether from his/her mouth. If the teether 400 unintentionally falls out of the child's mouth device 200 that connects to tether 300 prevents the teether from contacting an unwanted surface such as the ground below the child. Device 200 fills a need for an ergonomic and intuitive product that is adjustable and can be used with one hand. Device 200 is adjustable to different fabric thicknesses, and its ergonomic shape, ridge 235, and gripping material 390 make device 200 intuitive and easy to slide slider 250 in either direction. Device 200 improves a shape design, comfort of use, and is adaptable to fabrics of different thicknesses in comparison to products in the same category in the marketplace.

It should also be noted that the terms “first”, “second”, “third”, “upper”, “lower”, “above”, “below”, and the like may be used herein to modify various elements. These modifiers do not imply a spatial, sequential, or hierarchical order to the modified elements unless specifically stated.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the appended claims.

What is claimed is:

1. A securing device connected to a tether, the securing device comprising:
a first clamp portion having a first exterior surface and a first interior surface opposite the first exterior surface;
a second clamp portion having a second exterior surface and a second interior surface opposite the second exterior surface, the first clamp portion and the second clamp portion each having an end that is connected to one another at a connected portion and each having an opposite free end that is free to form a “C” shape, the connected portion connects the first clamp portion and the second clamp portion to bias the free ends away from each other;
a slider movably connected to the first clamp portion and the second clamp portion so that the slider is movable toward and away from the free ends; and
a ridge connected to the second exterior surface adjacent the free end of the second clamp portion so that the ridge protrudes from the second exterior surface to be engaged by a user while moving the slider.

2. The securing device of claim 1, wherein the first clamp portion has a first opening extending through both the first exterior surface and the first interior surface and the second clamp portion has a second opening extending through both the second exterior surface and the second interior surface.

3. The securing device of claim 2, wherein the slider is positioned through the first opening and the second opening so that the slider is movable in the first opening and the second opening.

4. The securing device of claim 3, wherein the slider moves toward and away from the free ends.

5. The securing device of claim 4, wherein the slider has a first base, a second base, and a post that connects the first base and the second base on opposite ends thereof.

6. The securing device of claim 5, wherein the post is positioned through the first opening and the second opening.

7. The securing device of claim 5, wherein the first base and the second base are substantially perpendicular to the post.

8. The securing device of claim 5, wherein the first base has a clamp surface that contacts the first exterior surface while the post moves towards and away from the free ends.

9. The securing device of claim 8, wherein the first base has a user surface opposite the clamp surface that has a gripping material thereon to provide friction between a user's fingers or thumbs when positioned on the gripping material assisting a user to move the slider toward and away from the first free end and the second free end.

10. The securing device of claim 5, wherein the second exterior surface has a plurality of protrusions forming a plurality of grooves between adjacent protrusions of the plurality of protrusions, and wherein the second base has at least one complementary protrusion that moves over the plurality of protrusions while the post moves towards and away from the free ends and is positioned within adjacent protrusions of the plurality of protrusions while the post is stationary maintaining the slider in place.

11. The securing device of claim 2, wherein the ridge is between the free end of the second clamp portion and the second opening.

12. The securing device of claim 11, wherein the ridge curves toward the second opening.

13. The securing device of claim 1, wherein the securing device is connected to a tether at one end, and wherein the tether connects a pacifier or teether on an end opposite the end connected to the securing device.

14. A securing device connected to a tether, the securing device comprising:
a first clamp portion having a first exterior surface, a first interior surface opposite the first exterior surface, and a first opening extending through both the first exterior surface and the first interior surface;
a second clamp portion having a second exterior surface, a second interior surface opposite the second exterior surface, and a second opening extending through both the second exterior surface and the second interior surface, the first clamp portion and the second clamp portion each having an end that is connected to one another at a connected portion and each having an opposite free end that is free to form a “C” shape, the connected portion connects the first clamp portion and the second clamp portion to bias the free ends away from each other and align the first opening so at least a portion overlaps the second opening;
a slider having a first base, a second base, and a post that connects the first base and the second base on opposite ends thereof, the post being positioned through the first opening and the second opening so that the post is movable in the first opening and the second opening toward and away from the free ends, the first base contacting the first exterior surface while the post moves towards and away from the free ends, and the second base contacting the second exterior surface while the post moves towards and away from the free ends, the first base having a first angle with the post and the second base having a second angle with the post so that upon movement of the post towards the free ends, the free ends move toward one another.

15. The securing device of claim 14, wherein the second exterior surface has a plurality of protrusions forming a plurality of grooves between adjacent protrusions of the plurality of protrusions, wherein the second base has at least one complementary protrusion that moves over the plurality of protrusions while the post moves towards and away from the free ends and is positioned within adjacent protrusions of the plurality of protrusions while the post is stationary maintaining the slider in place.

16. The securing device of claim 14, wherein the first base has a clamp surface that contacts the first exterior surface.

17. The securing device of claim 16, wherein the first base has a user surface opposite the clamp surface that has a gripping material thereon to provide friction between a user's fingers or thumbs when positioned on the gripping material assisting a user to move the slider toward and away from the first free end and the second free end.

18. The securing device of claim 14, wherein the securing device is connected to a tether at one end, and wherein the tether connects a pacifier or teether on an end opposite the end connected to the securing device.

19. The securing device of claim 14, wherein the first base and the second base are substantially perpendicular to the post.

20. A securing device connected to a tether, the securing device comprising:
a first clamp portion having a first exterior surface and a first interior surface opposite the first exterior surface;
a second clamp portion having a second exterior surface and a second interior surface opposite the second exterior surface, the first clamp portion and the second clamp portion each having an end that is connected to one another at a connected portion and each having an opposite free end that is free to form a “C” shape, the connected portion connects the first clamp portion and the second clamp portion to bias the free ends away from each other, said first clamp portion and said second clamp portion having a hourglass shape;
a slider movably connected to the first clamp portion and the second clamp portion so that the slider is movable toward and away from the free ends.
